(19) United States
(12) Patent Application Publication
(10) Pub. No.: US 2010/0039348 A1
(43) Pub. Date: Feb. 18, 2010

(54) ANTENNA DEVICE

(75) Inventors: Hsin-Wen Tsai, Taipei (TW); Chien-Lung Tseng, Taipei (TW); Chao-Jung Chen, Taipei (TW)

Correspondence Address: KIRTON AND MCCONKIE, 60 EAST SOUTH TEMPLE,, SUITE 1800, SALT LAKE CITY, UT, 84111, US

(73) Assignee: AVERMEDIA TECHNOLOGIES, INC., Taipei (TW)

(21) Appl. No.: 12/254,074

(22) Filed: Oct. 20, 2008

(30) Foreign Application Priority Data
Aug. 14, 2008 (TW) 097131032

(51) Int. Cl. H01Q 1/12

(52) U.S. Cl. 343/878

(57) ABSTRACT

An antenna device is detachably attached onto an object and includes an antenna main body and a securing module. The antenna main body has a surface. A first coupling part is formed on the surface. The securing module includes a second coupling part and a securing part. The second coupling part is connectable with the first coupling part. The securing part is flexible and deformable. A space is defined between the surface and the securing part for accommodating the object.

### FIELD OF THE INVENTION

The present invention relates to an antenna device, and more particularly to an antenna device having a deformable securing part such that the antenna device is attached onto an object or fixed on a placement plane.

### BACKGROUND OF THE INVENTION

Nowadays, many electrical appliances are widely used with computers due to the amazing power of computers. For example, the TV programs shown on a cable TV or a wireless television can be transmitted to the personal computer for playback. Typically, the TV signals issued from the TV set can be transmitted to the personal computer by externally wiring a TV box to the computer or inserting TV tuner card into the computer. In such way, the TV programs can be displayed on the personal computer in a wired or wireless transmission manner, and thus the personal computer has an extended function of serving as a TV set. With increasing development of mobile computing technology industries, a variety of portable electronic devices such as notebook computers or small-sized liquid crystal displays become essential electronic products because they are feasible to be used in many instances. For example, wireless TV signals (e.g. RF signals) can be received by an antenna device of an external or built-in TV tuner card of the notebook computer in order to achieve a function of viewing TV programs on a notebook computer.

FIG. 1 is a schematic perspective view illustrating connection between a notebook computer 10, a TV tuner card 12 and an antenna device 13. For example, the TV tuner card 12 is a Cardbus interface card, a high-speed transmission interface card (ExpressCard), a USB extension card, and the like. As shown in FIG. 1, the notebook computer 10 has a transmission interface 11 to be coupled with the TV tuner card 12. After the TV tuner card 12 is coupled with the transmission interface 11, the functions of the notebook computer 10 are expanded. After the TV tuner card 12 is connected to the antenna device 13, TV signals received by the antenna device 13 can be transmitted to the notebook computer 10 for playback.

After the notebook computer 10, the TV tuner card 12 and the antenna device 13 are communicated with each other, as is shown in FIG. 1, the antenna device 13 and the notebook computer 10 may be placed on identical or different placement planes or platforms. In addition, an extension antenna 131 of the antenna device 13 may be extended so as to enhance the performance of receiving wireless signals. For facilitating firm placement of the antenna device 13, the securing base 130 of the antenna device 13 is magnetically fixed on the placement plane or platform. The antenna device 13, however, still has some drawbacks. Since the securing base 130 of the antenna device 13 usually fails to be in close contact with the placement plane and the configuration of the antenna device 13 is improper, some drawbacks possibly occur. For example, the center of gravity is readily shifted or deviated when the antenna device 13 is suffered from vibration or contact or the direction of the extension antenna 131 is changed to receive wireless signals. In addition, the securing base 130 of the antenna device 13 occupies much space of the placement plane and becomes hindrance from operating the notebook computer 10.

Recently, some antenna devices have been disclosed for solving the above problems. For conforming to different placement planes, two antenna devices are illustrated with reference to FIGS. 2A and 2B. FIG. 2A is a schematic perspective view illustrating an antenna device 20 having a securing module 24 with a sucker. The antenna main body 21 has an antenna module 22 for receiving wireless signals. In addition, an indentation (not shown) formed in the bottom of the antenna main body 21; and corresponding to the indentation, a protrusion is formed on the securing module 24. For combining the securing module 24 with the antenna main body 21, after the protrusion is inserted into the indentation, the antenna main body 21 needs to be rotated by 90 degrees. Moreover, the sucker of the securing module 24 is deformable to be attracted on a desk or a plane. FIG. 2B is a schematic perspective view illustrating an antenna device 200 having a flexible securing module 240 with two securing plates. Likewise, an indentation (not shown) formed in the bottom of the antenna main body 21; and corresponding to the indentation, a protrusion is formed on the securing module 240. For combining the securing module 240 with the antenna main body 21, after the protrusion is inserted into the indentation, the antenna main body 21 needs to be rotated by 90 degrees. Moreover, after the two securing plates of the flexible securing module 240 are flexibly deformable, the two securing plates can clamp for example an upper edge of a LCD screen of a notebook computer. The antenna devices shown in FIGS. 2A and 2B are disclosed in Taiwanese Patent No. M335024, and the contents of which are hereby incorporated by reference.

Although the sucker of the securing module of FIG. 2A can be fixed on the placement plane, there is still some drawbacks. For example, since the antenna device is separated from the notebook computer, the antenna device occupies much space of the placement plane and becomes hindrance from operating the notebook computer. Furthermore, the gap between the two securing plates of the securing module of FIG. 2B is predetermined. Since the deformation amount of the securing plates is very tiny, the gap can be slightly adjusted. In other words, the determined gap of the securing module fails to conform to diverse thickness of various LCD screens of notebook computers. Consequently, the antenna device may fail to be attached onto the LCD screen in some situations.

Therefore, there is a need of providing an improved antenna device to obviate the drawbacks encountered from the prior art.

### SUMMARY OF THE INVENTION

The present invention provides an antenna device having a deformable securing part such that the antenna device is attached onto an object or fixed on a placement plane.

In an embodiment, the present invention provides an antenna device that is detachably attached onto an object and includes an antenna main body and a securing module. The antenna main body has a surface. A first coupling part is formed on the surface. The securing module includes a second coupling part and a securing part. The second coupling part is connectable with the first coupling part. The securing part is flexible and deformable. A space is defined between the surface and the securing part for accommodating the object.

In an embodiment, the present invention provides an antenna device that is detachably attached onto an object and includes an antenna main body and a securing module. The securing module includes a hanging stand and a securing part. The hanging stand has a receptacle for accommodating the antenna main body. The securing part is flexible and deformable. A space is defined between the hanging stand and the securing part for accommodating the object.

In an embodiment, the present invention provides an antenna device to be fixed on a placement plane. An antenna main body has an indentation formed in a bottom thereof. The securing module includes a coupling part and a securing part. The coupling part includes two lateral retaining walls and a protrusion. The protrusion is engaged with the indentation. The antenna main body is confined by the two lateral retaining walls. The securing part has a flexible sucker that is deformable to be fixed on the placement plane.

### BRIEF DESCRIPTION OF THE DRAWINGS

The above contents of the present invention will become more readily apparent to those ordinarily skilled in the art after reviewing the following detailed description and accompanying drawings, in which:

FIG. 1 is a schematic perspective view illustrating connection between a notebook computer 10, a TV tuner card 12 and an antenna device 13;

FIG. 2A is a schematic perspective view illustrating an antenna device 20 having a securing module 24 with a sucker;

FIG. 2B is a schematic perspective view illustrating an antenna device 200 having a flexible securing module 240 with two securing plates;

FIG. 3A is a schematic exploded view illustrating an antenna device according to a first embodiment of the present invention;

FIG. 3B is a schematic perspective view of the securing module 34 of the antenna device 30 as shown in FIG. 3A;

FIG. 3C is a schematic side view of the securing module 34 of the antenna device 30 as shown in FIG. 3A;

FIG. 3D is a schematic partial enlarged view of the first coupling part 33 formed in the surface 310 as shown in FIG. 3A;

FIG. 4A is a schematic assembled view of the antenna device 30 as shown in FIG. 3A;

FIG. 4B is a schematic side view of the antenna device 30 as shown in FIG. 4A;

FIG. 5A is a schematic side view illustrating the antenna device 30 attached onto an upper edge of a LCD screen of a notebook computer 10;

FIG. 5B is a schematic perspective view illustrating the antenna device 30 attached onto an upper edge of a LCD screen of a notebook computer 10;

FIG. 6A is a schematic exploded view illustrating an antenna device according to a second embodiment of the present invention;

FIG. 6B is a schematic side view of the securing module 44 of the antenna device 40 as shown in FIG. 3A;

FIG. 7A is a schematic assembled view of the antenna device 40 as shown in FIG. 6A;

FIG. 7B is a schematic side view of the antenna device 40 as shown in FIG. 7A;

FIG. 8 is a schematic side view illustrating the antenna device 40 attached onto an upper edge of a LCD screen of a notebook computer 10;

FIG. 9A is a schematic exploded view illustrating an antenna device according to a third embodiment of the present invention;

FIG. 9B is a schematic perspective view of the securing module 54 of the antenna device 50 as shown in FIG. 9A;

FIG. 9C is a schematic side view of the securing module 54 of the antenna device 50 as shown in FIG. 9A;

FIG. 10A is a schematic assembled view of the antenna device 50 as shown in FIG. 9A;

FIG. 10B is a schematic side view of the antenna device 50 as shown in FIG. 10A;

FIG. 11 is a schematic side view illustrating the antenna device 50 attached onto an upper edge of a LCD screen of a notebook computer 10;

FIG. 12A is a schematic exploded view illustrating an antenna device according to a fourth embodiment of the present invention;

FIG. 12B is a schematic perspective view of the securing module 540 of the antenna device 500 as shown in FIG. 12A;

FIG. 12C is a schematic side view of the securing module 540 of the antenna device 500 as shown in FIG. 12A;

FIG. 13A is a schematic assembled view of the antenna device 500 as shown in FIG. 12A;

FIG. 13B is a schematic side view of the antenna device 500 as shown in FIG. 13A;

FIG. 14 is a schematic side view illustrating the antenna device 500 attached onto an upper edge of a LCD screen of a notebook computer 10;

FIG. 15A is a schematic exploded view illustrating an antenna device according to a fifth embodiment of the present invention;

FIG. 15B is a schematic perspective view of the securing module 64 of the antenna device 60 as shown in FIG. 15A;

FIG. 15C is a schematic bottom view of the antenna main body 61 of the antenna device 60 as shown in FIG. 15A;

FIG. 16A is a schematic assembled view of the antenna device 60 as shown in FIG. 15A; and

FIG. 16B is a schematic perspective view illustrating the antenna device 50 placed on a desk plane.

### DETAILED DESCRIPTION OF THE PREFERRED EMBODIMENT

The present invention will now be described more specifically with reference to the following embodiments. It is to be noted that the following descriptions of preferred embodiments of this invention are presented herein for purpose of illustration and description only. It is not intended to be exhaustive or to be limited to the precise form disclosed.

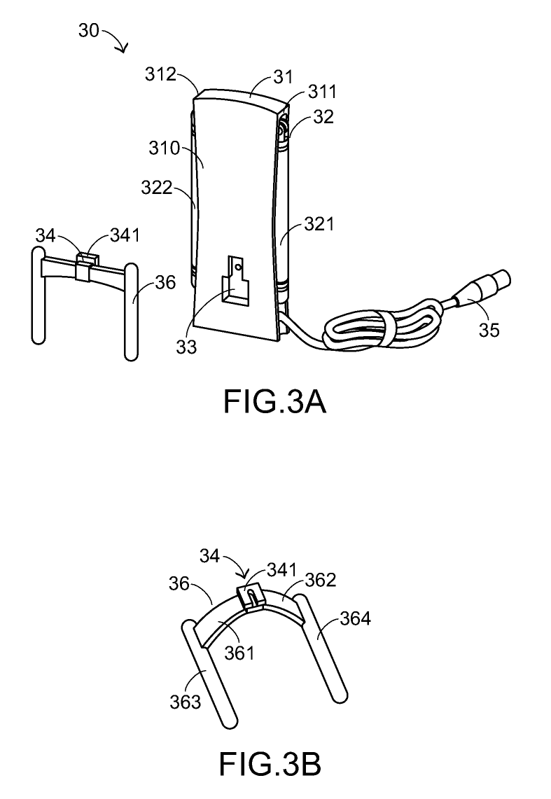

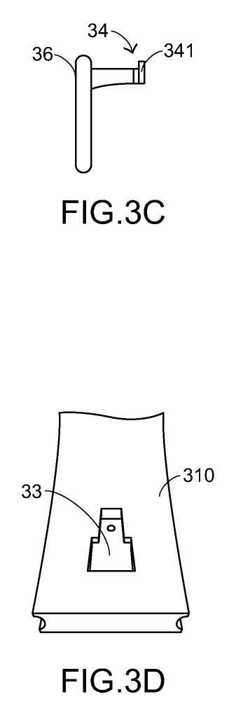

FIG. 3A is a schematic exploded view illustrating an antenna device according to a first embodiment of the present invention. As shown in FIG. 3A, the antenna device 30 principally comprises an antenna main body 31 and a securing module 34. The antenna main body 31 comprises an antenna module 32 including a first antenna part 321 and a second antenna part 322. The first antenna part 321 and the second antenna part 322 are pivotally mounted on bilateral sides 311 and 312 of the antenna main body 31. The securing module 34 is detachably coupled with the antenna main body 31. For illustration, as shown in FIG. 3A, the antenna main body 31 and the securing module 34 are separated from each other. A first coupling part 33 is formed in a surface 310 of the antenna main body 31. Corresponding to the first coupling part 33, a second coupling part 341 is formed on the securing module 34. The securing module 34 also has a securing part 36. When the second coupling part 341 and the first coupling part 33 are engaged with each other, the securing module 34 and the antenna main body 31 are combined together. In accordance with a key feature of the present invention, a space is defined between the surface 310 and the securing part 36 for accommodating an object therein such that the antenna device 30 is attached onto the object. Alternatively, the object may be clamped between the surface 310 and the securing part 36 in order for facilitating firmly fixing the antenna device 30.

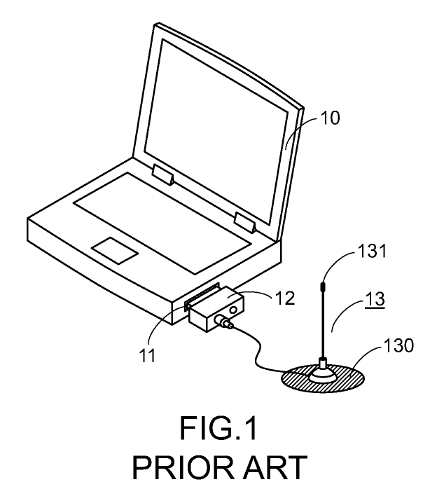

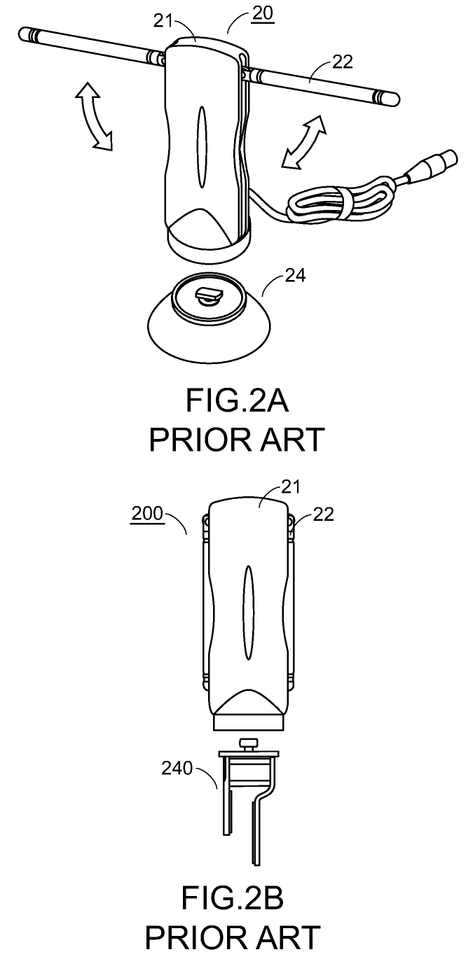

The antenna device 30 of the present invention can be adapted to a wireless signal transmission interface. In other words, the antenna device 30 can be applied to a notebook computer 10 with a TV tuner card 12 as shown in FIG. 1. The antenna device 30 further comprises a circuit board (not shown) and a signal output terminal 35. The circuit board is mounted within the antenna main body 31. The signal output terminal 35 and the antenna parts 321 and 322 of the antenna module 32 are electrically connected to the circuit board. After the signal output terminal 35 is electrically connected to a transmission interface (e.g. a TV tuner card 12 as shown in FIG. 1), the antenna device 30 executes a function of receiving wireless signals (e.g. wireless TV signals). The wireless signals received by the antenna parts 321 and 322 of the antenna module 32 are processed by the circuit board, and then the processed wireless signals are transmitted to the transmission interface through the signal output terminal 35.

FIG. 3B is a schematic perspective view of the securing module 34 of the antenna device 30 as shown in FIG. 3A. FIG. 3C is a schematic side view of the securing module 34 of the antenna device 30 as shown in FIG. 3A. Please refer to FIGS. 3B and 3C. The securing part 36 of the securing module 34 comprises two flexible segments 361, 362, and two posts 363, 364. Due to flexible properties of the flexible segments 361, 362, the flexible segments 361 and 362 may be subject to flexible deformation. The flexible segment 361 has one end connected to the second coupling part 341 and the other end connected to the post 363. Similarly, the flexible segment 362 has one end connected to the second coupling part 341 and the other end connected to the post 364. It is preferred that the securing part 36 is completely made of flexible material. Alternatively, in some embodiments, only these two flexible segments 361 and 362 are made of flexible or deformable material. Through the transmission mechanism, the relative locations between the posts 363 and 364 are adjustable by manipulating the flexible segments 361 and 362.

FIG. 3D is a schematic partial enlarged view of the first coupling part 33 formed in the surface 310 as shown in FIG. 3A. The first coupling part 33 and the second coupling part 341 have complementary shapes. When the second coupling part 341 and the first coupling part 33 are engaged with each other, the securing module 34 and the antenna main body 31 are combined together.

Please refer to FIGS. 3A, 3B, 3C and 3D. An exemplary first coupling part 33 is a guide slot. Corresponding to the guide slot, the second coupling part 341 is a guide track. For assembling the antenna device 30, the second coupling part 341 is firstly accommodated in a hollow entrance of the first coupling part 33 that is formed in the surface 310, and then the second coupling part 341 is embedded into the first coupling part 33 through engagement between the guide track and the guide slot. As shown in FIG. 3D, the upper-half portion of the hollow entrance is narrower than the lower-half portion. In addition, the width and the depth of the inner wall of the first coupling part 33 are elaborated controlled such that the second coupling part 341 and the first coupling part 33 can be engaged with each other. It is noted that, however, those skilled in the art will readily observe that numerous modifications and alterations may be made while retaining the teachings of the invention. For example, in some embodiments, a salient may be formed on the bottom (or an inner case) of the first coupling part 33 and a corresponding recess may be formed in the second coupling part 341. The salient may be received in the recess in order for facilitating firm engagement between the first coupling part 33 and the second coupling part 341.

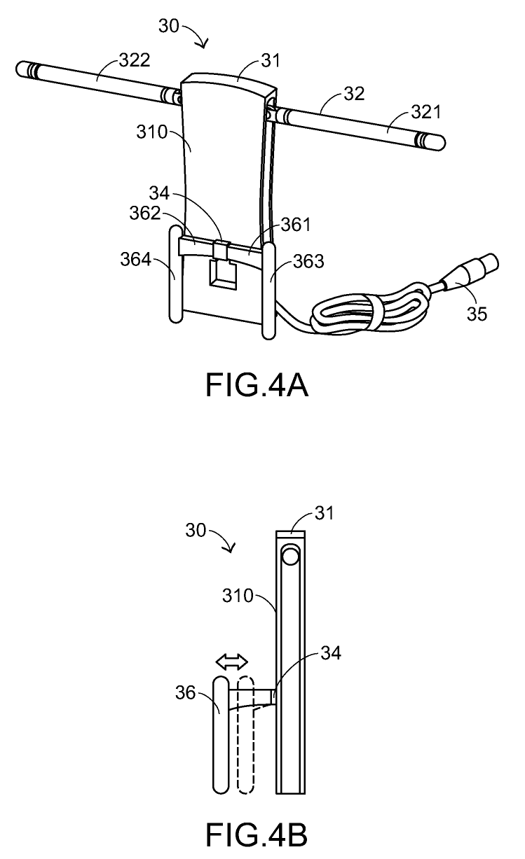

FIG. 4A is a schematic assembled view of the antenna device 30 as shown in FIG. 3A. FIG. 4B is a schematic side view of the antenna device 30 as shown in FIG. 4A. Please refer to FIGS. 4A and 4B. The antenna parts 321 and 322 of the antenna module 32 are unfolded to be horizontal with respect to the placement plane or platform. Like the extensible antenna as described in the prior art, the antenna parts 321 and 322 of the antenna module 32 are also extensible in order to enhance the performance of receiving wireless signals. Based on the electromagnetic wave theory, these two antenna parts that are horizontally arranged in the dipole antenna configuration have an excellent efficacy for receiving wireless signals. After the securing module 34 and the antenna main body 31 are combined together as the antenna device 30, the antenna device 30 may be attached onto an object.

Please refer to FIGS. 4A and 4B again. Since the flexible segments 361 and 362 of the securing part 36 are flexible and deformable, the distance between the posts 363, 364 and the surface 310 of the antenna main body 31 is adjustable in order to the conform to the thickness of the object. In this embodiment, the flexible segments 361 and 362 have flexibility similar to hoses. In response to external forces exerted on the flexible segments 361 and 362, the flexible segments 361 and 362 are subject to deformation and thus the posts 363 and 364 are shifted while maintaining their shapes. In a case that the external forces are relieved, the posts 363 and 364 returns to their original locations. After the flexible segments 361 and 362 of the securing part 36 are flexibly deformable in the direction indicated as the arrow, the object will be clamped between the securing part 36 of the securing module 34 and the surface 310 of the antenna main body 31. Meanwhile, the antenna device 30 is securely attached onto the object.

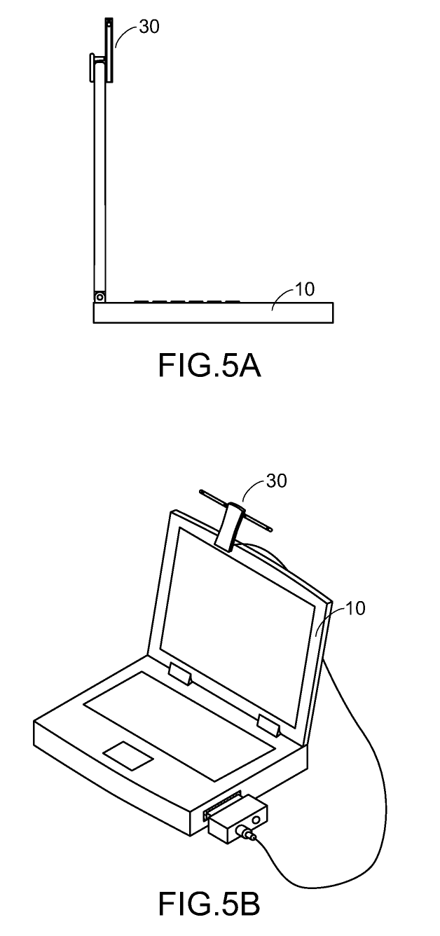

An exemplary object is a liquid crystal display (LCD) screen. FIGS. 5A and 5B are respectively schematic side and perspective views illustrating the antenna device 30 attached onto an upper edge of a LCD screen of a notebook computer 10. For conforming to the thickness of the LCD screen of the notebook computer 10, corresponding deformation of the flexible segments 361 and 362 is rendered. In particular, the deformation amounts of the flexible segments 361 and 362 should be slightly greater than the thickness of the LCD screen of the notebook computer 10 such that a space between the securing part 36 and the surface 310 of the antenna main body 31 is sufficient for accommodating the LCD screen therein. Since the upper edge of the LCD screen is clamped by the antenna device 30, the antenna device 30 can be firmly attached onto the LCD screen. For a purpose of attaching the antenna device 30 on another location of the LCD screen, the user may exert external forces on the flexible segments 361 and 362 to separate the posts 363 and 364 from the LCD screen and then withdraw the antenna device 30. Next, the antenna device 30 may be attached onto another desired location of the LCD screen by the above procedures. From the above description, the antenna device 30 may be attached onto the upper edge of the LCD screen. In addition, the clamping distance of the antenna device 30 is determined according to the thickness of the LCD screen, so that the antenna device 30 can be firmly attached onto the LCD screen.

In the first embodiment of the present invention, when the flexible segments 361 and 362 are subject to deformation, the LCD screen will be clamped between the posts 363, 364 and the surface 310 of the antenna main body 31. Based on such a concept, some components of the antenna device 30 may be modified in structure or appearance. For example, the flexible segments 361 and 362 are both flexible and elastic such that the securing part functions as an elastic clamp. By way of an inclination that the flexible segments are elastically recovered from deformation, the posts of the securing part can be more firmly attached onto the object (e.g. a LCD screen of a notebook computer). Alternatively, the securing part of the elastic clamp may have only one securing plate in replace of the two posts, so that the upper edge of LCD screen is directly clamped between the securing plate and the surface of the antenna main body.

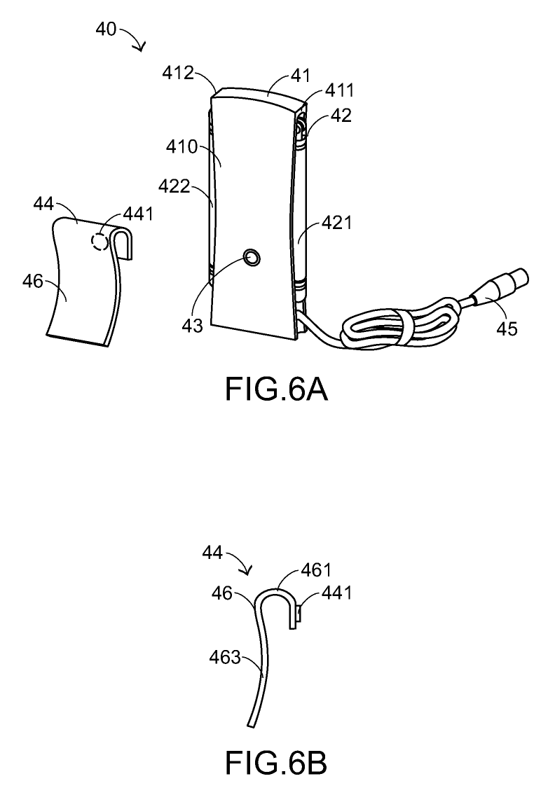

FIG. 6A is a schematic exploded view illustrating an antenna device according to a second embodiment of the present invention. As shown in FIG. 6A, the antenna device 40 principally comprises an antenna main body 41 and a securing module 44. The antenna main body 41 comprises an antenna module 42 including antenna parts 321 and 322. The antenna parts 421, 422 and the signal output terminal 35 included in this embodiment are similar to those shown in FIG. 3A, and are not redundantly described herein. In contrast, the configuration of the securing module 44 and the connecting mechanism between the first coupling part 33 and the second coupling part 341 are distinguished from the second embodiment. Similarly, a first coupling part 43 is formed in a surface 410 of the antenna main body 41; and corresponding to the first coupling part 43, a second coupling part 441 is formed on the securing module 44. The securing module 44 also has a securing part 46. Likewise, a space is defined between the surface 410 and the securing part 46 for accommodating an object therein such that the antenna device 40 is attached onto the object. Alternatively, the object may be clamped between the surface 410 and the securing part 46 in order for facilitating firmly fixing the antenna device 40.

FIG. 6B is a schematic side view of the securing module 44 of the antenna device 40 as shown in FIG. 3A. The securing part 46 of the securing module 44 comprises a flexible segment 461 and a securing plate 463. The flexible segment 461 has a crooked shape and is made of flexible material. Due to a flexible property of the flexible segment 461, the flexible segment 461 may be subject to flexible deformation. The flexible segment 461 has one end connected to the second coupling part 441 and the other end connected to the securing plate 463. Likewise, the first coupling part 43 and the second coupling part 441 have complementary shapes. In this embodiment, the first coupling part 43 and the second coupling part 441 are a female buckle and a male buckle, respectively. When the second coupling part 441 and the first coupling part 43 are engaged with each other, the securing module 44 and the antenna main body 41 are combined together. It is noted that, however, those skilled in the art will readily observe that numerous modifications and alterations may be made while retaining the teachings of the invention. For example, in some embodiments, the first coupling part 43 and the second coupling part 441 are a male buckle and a female buckle, respectively.

Since the flexible segment 461 of the securing part 46 is flexible and deformable, the distance between the securing plate 463 and the surface 410 of the antenna main body 41 is adjustable in order to the conform to the thickness of the object. It is preferred that the securing part 46 is completely made of flexible material. Alternatively, in some embodiments, only the flexible segment 461 is made of flexible or deformable material. Through the transmission mechanism, the location of the securing plate 463 relative to the flexible segment 461 is adjustable by manipulating the flexible segment 461.

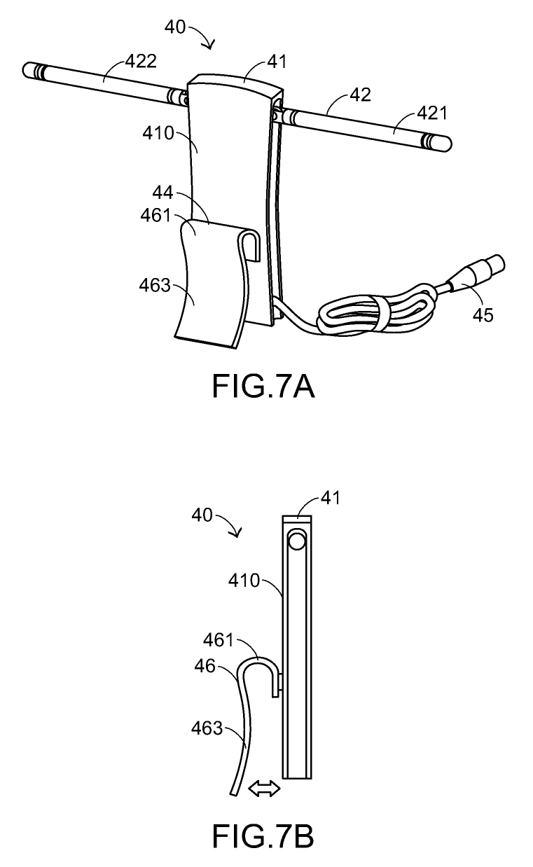

FIG. 7A is a schematic assembled view of the antenna device 40 as shown in FIG. 6A. FIG. 7B is a schematic side view of the antenna device 40 as shown in FIG. 7A. Please refer to FIGS. 7A and 7B. The antenna parts 421 and 422 of the antenna module 42 are unfolded to be horizontal with respect to the placement plane or platform. Since the antenna parts 421 and 422 of the antenna module 42 are horizontally arranged in the dipole antenna configuration, the performance of receiving wireless signals is enhanced. After the securing module 44 and the antenna main body 41 are combined together as the antenna device 40, the antenna device 40 may be attached onto an object (e.g. a LCD screen of a notebook computer).

Please refer to FIGS. 7A and 7B again. Since the flexible segment 461 of the securing part 46 is flexible and deformable, the distance between the securing plate 463 of the securing part 46 and the surface 410 of the antenna main body 41 is adjustable in order to the conform to the thickness of the LCD screen. In this embodiment, the flexible segment 461 is also elastic. In response to an external force exerted on the flexible segment 461, the flexible segment 461 is subject to deformation and the securing plate 463 is shifted. By way of an inclination that the flexible segment 461 is elastically recovered from deformation, the securing plate 463 of the securing part 46 can be more firmly attached onto the LCD screen. In other words, after the flexible segment 461 of the securing part 46 is flexibly deformable in the direction indicated as the arrow, the LCD screen will be clamped between the securing part 46 of the securing module 44 and the surface 410 of the antenna main body 41. Meanwhile, the antenna device 40 is securely attached onto the LCD screen.

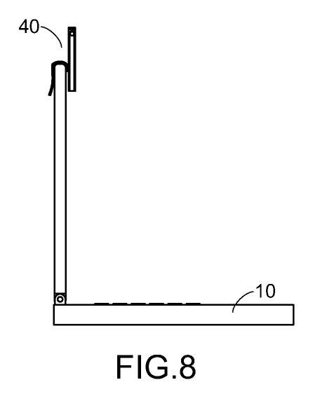

FIG. 8 is a schematic side view illustrating the antenna device 40 attached onto an upper edge of a LCD screen of a notebook computer 10. According to the thickness of the LCD screen of the notebook computer 10, corresponding deformation of the flexible segment 461 is rendered. In particular, the deformation amounts of the flexible segment 461 should be slightly greater than the thickness of the LCD screen of the notebook computer 10 such that a space between the securing part 46 and the surface 410 of the antenna main body 41 is sufficient for accommodating the LCD screen therein. Since the upper edge of the LCD screen is clamped by the antenna device 40, the antenna device 30 can be firmly attached onto the LCD screen of the notebook computer 10. Similarly, the antenna device 40 may be detachably attached onto another location of the LCD screen by the procedure as described above. The perspective view of the antenna device attached onto the notebook computer is similar to that shown in FIG. 5B.

In the above two embodiments, when one or two flexible segments are subject to deformation, the object will be clamped between the securing plate or the two posts and the surface of the antenna main body. Moreover, these flexible segments are also elastic. By way of an inclination that the flexible segments are elastically recovered from deformation, the antenna device can be firmly attached onto the object. The first and second coupling parts used in the first and second embodiments of the present invention are not restricted to the guide slot/guide track or the female buckle/male buckle. For example, the first and second coupling parts may be respectively a female buckle and a male buckle in the first embodiment or respectively a guide slot and a guide track in the second embodiment. When the first and second coupling parts are engaged with each other, the securing module and the antenna main body are combined together so as to assemble the antenna device. The means of combining the securing module and the antenna main body may be changed by further modifying the coupling parts.

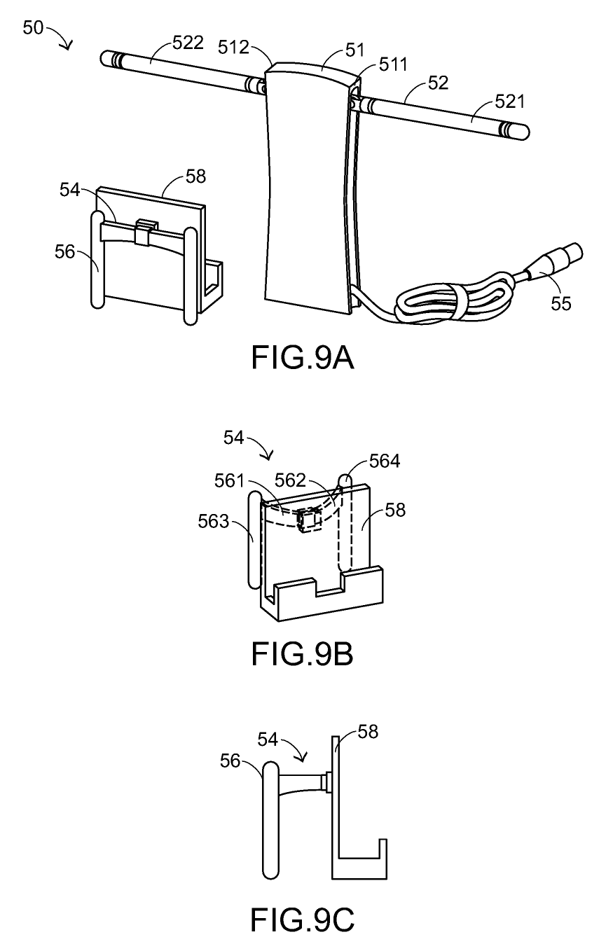

FIG. 9A is a schematic exploded view illustrating an antenna device according to a third embodiment of the present invention. As shown in FIG. 9A, the antenna device 50 principally comprises an antenna main body 51 and a securing module 54. The antenna main body 51 comprises an antenna module 52 including antenna parts 521 and 522. The antenna parts 521, 522 and the signal output terminal 55 included in this embodiment are similar to those shown in FIG. 3A, and are not redundantly described herein. The securing module 54 comprises a securing part 56 and a hanging stand 58. The configuration of the securing part 56 is similar to the securing part 36 as shown in FIG. 3A. Likewise, the securing part 56 has two flexible segments 561, 562, and two posts 563, 564. In contrast, no coupling part is formed on the antenna main body 51. The hanging stand 58 of the securing module 54 has a receptacle for accommodating the antenna main body 51 therein. In addition, the antenna parts 521 and 522 are pivotal in the receptacle. Likewise, a space is defined between the hanging stand 58 and the securing part 56 for accommodating an object therein such that the antenna device 50 is attached onto the object. Alternatively, the object may be clamped between the hanging stand 58 and the securing part 56 in order for facilitating firmly fixing the antenna device 50.

FIG. 9B is a schematic perspective view of the securing module 54 of the antenna device 50 as shown in FIG. 9A. FIG. 9C is a schematic side view of the securing module 54 of the antenna device 50 as shown in FIG. 9A. Please refer to FIGS. 9B and 9C. The securing part 56 of the securing module 54 comprises two flexible segments 561, 562, and two posts 563, 564. Due to flexible properties of the flexible segments 561, 562, the flexible segments 561 and 562 may be subject to flexible deformation. The flexible segment 561 has one end connected to the hanging stand 58 and the other end connected to the post 563. Similarly, the flexible segment 562 has one end connected to the hanging stand 58 and the other end connected to the post 564.

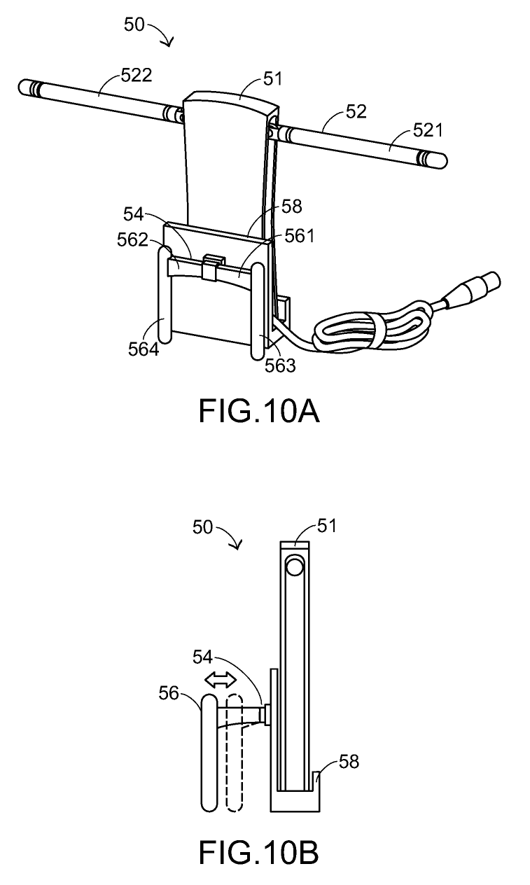

FIG. 10A is a schematic assembled view of the antenna device 50 as shown in FIG. 9A. FIG. 10B is a schematic side view of the antenna device 50 as shown in FIG. 10A. Please refer to FIGS. 10A and 10B. Since the antenna parts 521 and 522 of the antenna module 52 are horizontally arranged in the dipole antenna configuration, the performance of receiving wireless signals is enhanced. After the securing module 54 and the antenna main body 51 are combined together as the antenna device 50, the antenna device 50 may be attached onto an object (e.g. a LCD screen of a notebook computer).

Please refer to FIGS. 10A and 10B again. Since the flexible segments 561 and 562 of the securing part 56 are flexible and deformable, the distance between the flexible segments 561, 562 of the securing part 56 and the hanging stand 58 is adjustable in order to the conform to the thickness of the LCD screen. In this embodiment, the flexible segments 561 and 562 are also elastic. In response to external forces exerted on the flexible segments 561 and 562, the flexible segments 561 and 562 are subject to deformation and the posts 563 and 564 are shifted. By way of an inclination that the flexible segments 561 and 562 are elastically recovered from deformation, the posts 563 and 564 of the securing part 56 can be more firmly attached onto the LCD screen. In other words, after the flexible segments 561 and 562 of the securing part 56 is flexibly deformable in the direction indicated as the arrow, the LCD screen will be clamped between the securing part 56 of the securing module 54 and the hanging stand 58. Meanwhile, the antenna device 50 is securely attached onto the LCD screen.

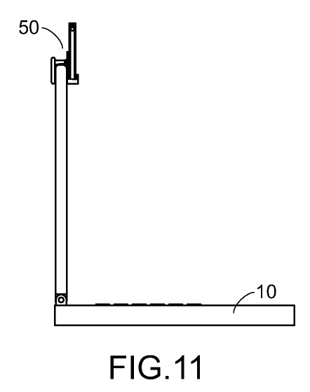

FIG. 11 is a schematic side view illustrating the antenna device 50 attached onto an upper edge of a LCD screen of a notebook computer 10. According to the thickness of the LCD screen of the notebook computer 10, corresponding deformation of the flexible segments 561 and 562 is rendered. In particular, the deformation amounts of the flexible segments 561 and 562 should be slightly greater than the thickness of the LCD screen of the notebook computer 10 such that a space between the securing part 56 and the hanging stand 58 is sufficient for receiving the LCD screen therein. Similarly, the antenna device 50 may be detachably attached onto another location of the LCD screen by the procedure as described above. The perspective view of the antenna device attached onto the notebook computer is similar to that shown in FIG. 5B.

In the third embodiment, the securing module comprises a hanging stand and a securing part having two flexible segments and two posts similar to the first embodiment. In a further embodiment, the securing module may comprise a hanging stand and a securing part having a flexible segments and a securing plate similar to the second embodiment, the upper edge of LCD screen is directly clamped between the securing plate and the surface of the antenna main body.

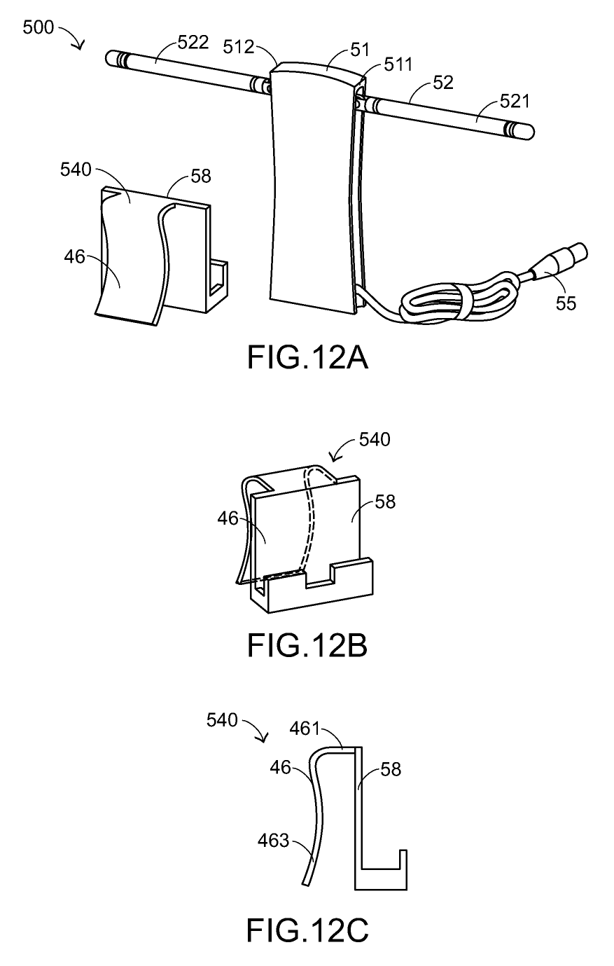

FIG. 12A is a schematic exploded view illustrating an antenna device according to a fourth embodiment of the present invention. As shown in FIG. 12A, the antenna device 500 principally comprises an antenna main body 51 and a securing module 540. The antenna main body 51 comprises an antenna module 52 including antenna parts 521 and 522. The antenna device of the fourth embodiment is modified on basis of the second and third embodiments. In the securing module 540 of the fourth embodiment, the securing part 56 of the third embodiment is replaced by the securing part 46 of the securing module 44 of the second embodiment. FIG. 12B is a schematic perspective view of the securing module 540 of the antenna device 500 as shown in FIG. 12A. FIG. 12C is a schematic side view of the securing module 540 of the antenna device 500 as shown in FIG. 12A. Please refer to FIGS. 12B and 12C. Likewise, the hanging stand 58 of the securing module 540 has a receptacle for accommodating the antenna main body 51 therein. The securing part 46 of the securing module 54 comprises a flexible segment 461 and a securing plate 463. An end of the flexible segment 461 is connected to the securing plate 463. The other end of the flexible segment 461 is connected to the upper edge of the backside of hanging stand 58. In the third and fourth embodiments, the securing part is disposed on the backside of hanging stand. It is preferred that the securing part is integrally formed with the hanging stand.

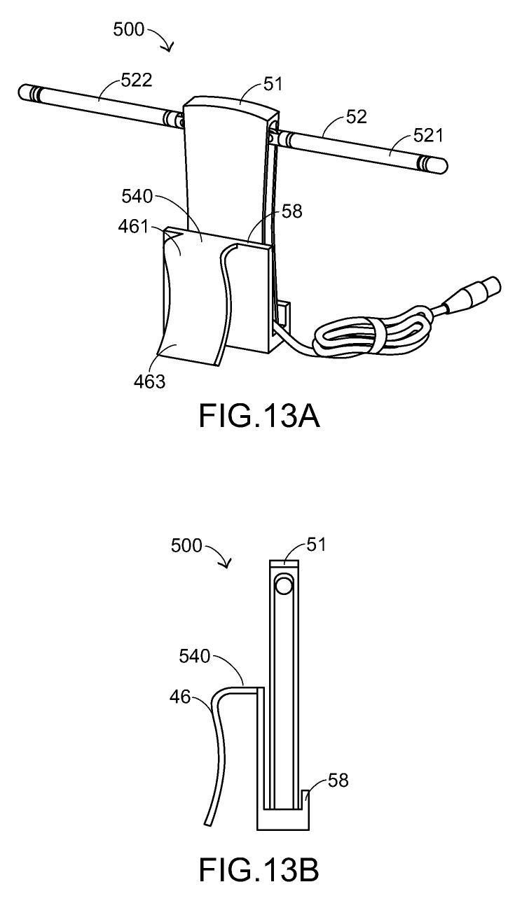

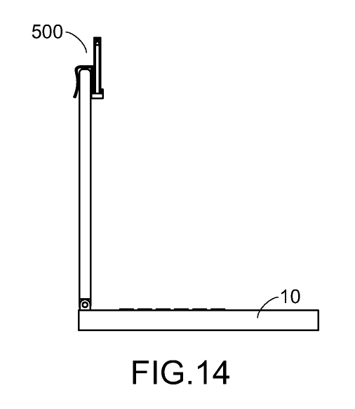

FIG. 13A is a schematic assembled view of the antenna device 500 as shown in FIG. 12A. FIG. 13B is a schematic side view of the antenna device 500 as shown in FIG. 13A. Please refer to FIGS. 13A and 13B. FIG. 14 is a schematic side view illustrating the antenna device 500 attached onto an upper edge of a LCD screen of a notebook computer 10.

In the third and fourth embodiments, the hanging stand has a receptacle for accommodating the antenna main body therein. The shape of the hanging stand is not restricted as long as the receptacle of the hanging stand is effective for accommodating the antenna main body therein.

In the above four embodiments, the antenna device is attached onto an upper edge of a LCD screen of a notebook computer. For complying with diverse requirements, the antenna device of the present invention may be further modified in order to be placed on an ordinary desk or plane.

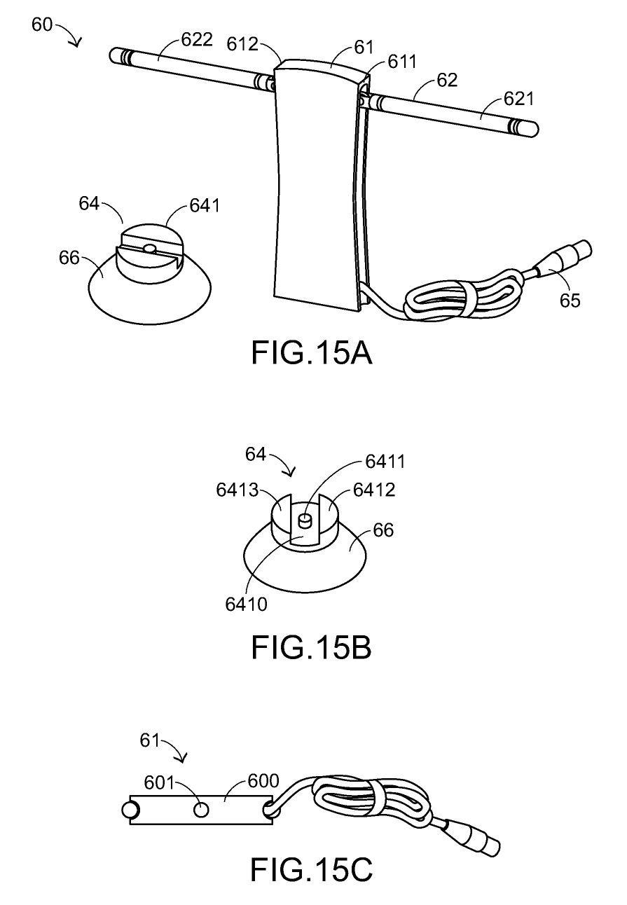

FIG. 15A is a schematic exploded view illustrating an antenna device according to a fifth embodiment of the present invention. As shown in FIG. 15A, the antenna device 60 principally comprises an antenna main body 61 and a securing module 64. The antenna main body 61 comprises an antenna module 62 including antenna parts 621 and 622. The antenna parts 621, 622 and the signal output terminal 65 included in this embodiment are similar to those described in the above four embodiments, and are not redundantly described herein. FIG. 15B is a schematic perspective view of the securing module 64 of the antenna device 60 as shown in FIG. 15A. FIG. 15C is a schematic bottom view of the antenna main body 61 of the antenna device 60 as shown in FIG. 15A. In this embodiment, an indentation 601 is formed in the bottom 600 of the antenna main body 61. In particular, the indentation 601 is formed the bottom 600 of the antenna main body 61 by drilling without any other component. In addition, the securing part 66 of the securing module 64 is a flexible sucker that is deformable to be attracted on the placement plane or platform. The

Please refer to FIGS. 15A, 15B and 15C again. The securing module 64 has a coupling part 641. Corresponding to the indentation 601, the coupling part 641 has a protrusion 6411, which is disposed within an elongate groove 6410 defined between two lateral retaining walls 6412 and 6413. When the protrusion 6411 and the protrusion 6411 are engaged with each other, the securing module 64 and the antenna main body 61 are combined together. Moreover, the lateral retaining walls 6412 and 6413 can facilitate confining the lower edge of the antenna main body 61, so that the securing module 64 and the antenna main body 61 are firmly combined together.

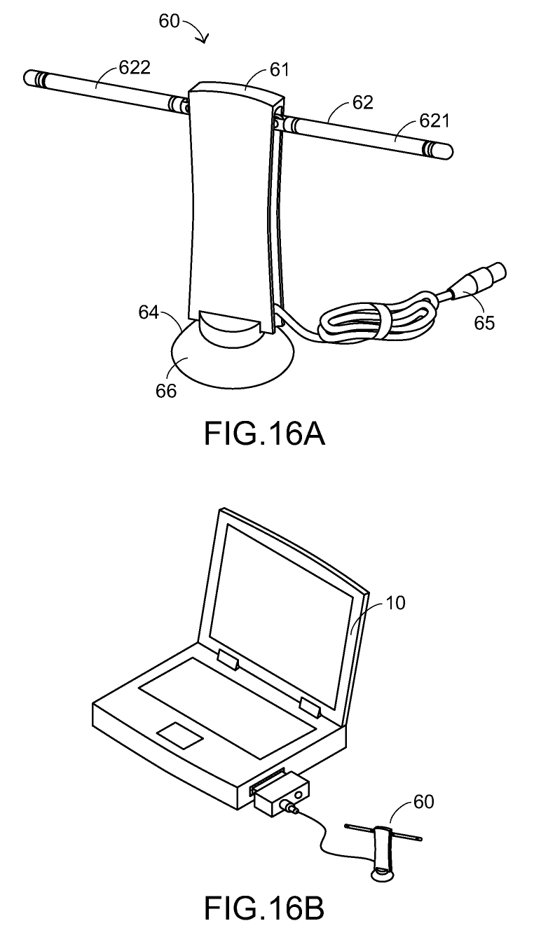

FIG. 16A is a schematic assembled view of the antenna device 60 as shown in FIG. 15A. The securing module 64 may be adapted to any antenna main body as described in the above embodiments. For placing the antenna device on the placement plane or platform, the user may firstly detach the hanging-type or clamping-type securing module from the upper edge of the LCD screen and then combine the antenna main body with the securing module 64. Since the securing part 66 of the securing module 64 is a flexible sucker, the securing part 66 is deformable to be attracted on the placement plane or platform. FIG. 16B is a schematic perspective view illustrating the antenna device 50 placed on a desk plane.

From the above description, the antenna device of the present invention can be attached onto an object or fixed on a placement plane according to the practical requirements. The antenna device of the present invention can be firmly attached onto the upper edge of the LCD screen of the notebook computer. In addition, the procedures of changing the location of the antenna device and detaching the antenna device from the LCD screen are very simple and convenient. In addition, since the securing module to be fixed on the ordinary desk or plane is made of cost-effective material, the costs of the antenna main body and the securing module are both reduced without impairing the performance of receiving wireless signal.

While the invention has been described in terms of what is presently considered to be the most practical and preferred embodiments, it is to be understood that the invention needs not to be limited to the disclosed embodiment. On the contrary, it is intended to cover various modifications and similar arrangements included within the spirit and scope of the appended claims which are to be accorded with the broadest interpretation so as to encompass all such modifications and similar structures.

What is claimed is:

1. An antenna device detachably attached onto an object, comprising:
an antenna main body having a surface, on which a first coupling part is formed; and
a securing module comprising a second coupling part and a securing part, wherein the second coupling part is connectable with the first coupling part, the securing part is flexible and deformable, and a space is defined between the surface and the securing part for accommodating the object.

2. The antenna device according to claim 1 wherein the antenna main body comprises:
a first lateral side;
a second lateral side; and
an antenna module comprising a first antenna part and a second antenna part, which are pivotally mounted on the first lateral side and the second lateral side of the antenna main body, respectively.

3. The antenna device according to claim 2 further comprising a circuit board disposed within the antenna main body and a signal output terminal, wherein the first antenna part, the second antenna part and the signal output terminal are all electrically connected to the circuit board, and a wireless signal received by the first or second antenna part is processed by the circuit board and outputted through the signal output terminal.

4. The antenna device according to claim 1 wherein the securing part of the securing module comprises:
a first flexible segment being deformable and having one end connected to the second coupling part;
a second flexible segment being deformable and having one end connected to the second coupling part;
a first post connected to the other end of the first flexible segment; and
a second post connected to the other end of the second flexible segment;
wherein the first flexible segment and the second flexible segment are deformable such that a distance between the first or second post and the surface of the antenna main body is adjustable.

5. The antenna device according to claim 4 wherein the first and second flexible segments are elastic so that the first and second posts are firmly attached onto the object by way of an inclination that the first and second flexible segments are elastically recovered from deformation.

6. The antenna device according to claim 1 wherein the securing part of the securing module comprises:
a first flexible segment having a crooked shape and being deformable, and having one end connected to the second coupling part; and
a securing plate connected to the other end of the first flexible segment;
wherein the first flexible segment is deformable such that a distance between the securing plate and the surface of the antenna main body is adjustable.

7. The antenna device according to claim 6 wherein the first flexible segment is elastic so that the securing plate is firmly attached onto the object by way of an inclination that the first flexible segment is elastically recovered from deformation.

8. The antenna device according to claim 1 wherein the object is a LCD screen, and the securing part is deformable to adjust the distance between the securing part and the surface of the antenna main body to conform to the thickness of the LCD screen.

9. The antenna device according to claim 1 wherein the first coupling part is a guide slot, the second coupling part is a guide track corresponding to the guide slot, and the antenna main body is combined with the securing module when the first coupling part and the second coupling part are engaged with each other.

10. The antenna device according to claim 1 wherein the first coupling part is a female buckle, the second coupling part is a male buckle corresponding to the female buckle, and the antenna main body is combined with the securing module when the first coupling part and the second coupling part are engaged with each other.

11. An antenna device detachably attached onto an object, comprising:
an antenna main body; and
a securing module comprising a hanging stand and a securing part, wherein the hanging stand has a receptacle for accommodating the antenna main body, the securing part is flexible and deformable, and a space is defined between the hanging stand and the securing part for accommodating the object.

12. The antenna device according to claim 11 wherein the antenna main body comprises:
a first lateral side;
a second lateral side; and
an antenna module comprising a first antenna part and a second antenna part, which are pivotally mounted on the first lateral side and the second lateral side of the antenna main body, respectively.

13. The antenna device according to claim 12 further comprising a circuit board disposed within the antenna main body and a signal output terminal, wherein the first antenna part, the second antenna part and the signal output terminal are all electrically connected to the circuit board, and a wireless signal received by the first or second antenna part is processed by the circuit board and outputted through the signal output terminal.

14. The antenna device according to claim 11 wherein the securing part of the securing module comprises:
a first flexible segment being deformable and having one end connected to the hanging stand;
a second flexible segment being deformable and having one end connected to the hanging stand;
a first post connected to the other end of the first flexible segment; and
a second post connected to the other end of the second flexible segment;
wherein the first flexible segment and the second flexible segment are deformable such that a distance between the first or second post and the hanging stand is adjustable.

15. The antenna device according to claim 14 wherein the first and second flexible segments are elastic so that the first and second posts are firmly attached onto the object by way of an inclination that the first and second flexible segments are elastically recovered from deformation.

16. The antenna device according to claim 11 wherein the securing part of the securing module comprises:
a first flexible segment having a crooked shape and being deformable, and having one end connected to the hanging stand; and
a securing plate connected to the other end of the first flexible segment;
wherein the first flexible segment is deformable such that a distance between the securing plate and the hanging stand is adjustable.

17. The antenna device according to claim 16 wherein the first flexible segment is elastic so that the securing plate is firmly attached onto the object by way of an inclination that the first flexible segment is elastically recovered from deformation.

18. The antenna device according to claim 11 wherein the object is a LCD screen, and the securing part is deformable to adjust the distance between the securing part and the hanging stand to conform to the thickness of the LCD screen.

19. An antenna device to be fixed onto a placement plane, comprising:
an antenna main body having an indentation formed in a bottom thereof; and
a securing module comprising a coupling part and a securing part;
wherein the coupling part comprises two lateral retaining walls and a protrusion, the protrusion is engaged with the indentation, the antenna main body is confined by the two lateral retaining walls, and the securing part has a flexible sucker that is deformable to be fixed onto the placement plane.

20. The antenna device according to claim 19 wherein the antenna main body comprises:
a first lateral side;
a second lateral side; and
an antenna module comprising a first antenna part and a second antenna part, which are pivotally mounted on the first lateral side and the second lateral side of the antenna main body, respectively.

21. The antenna device according to claim 20 further comprising a circuit board disposed within the antenna main body and a signal output terminal, wherein the first antenna part, the second antenna part and the signal output terminal are all electrically connected to the circuit board, and a wireless signal received by the first or second antenna part is processed by the circuit board and outputted through the signal output terminal.

22. The antenna device according to claim 19 wherein the placement plane is a desk plane.
